(19) United States
(12) Patent Application Publication
(10) Pub. No.: US 2018/0272611 A1
(43) Pub. Date: Sep. 27, 2018

(54) DEVICE AND GENERATIVE LAYER-BUILDING PROCESS FOR PRODUCING A THREE-DIMENSIONAL OBJECT BY MULTIPLE BEAMS

(71) Applicant: EOS GMBH ELECTRO OPTICAL SYSTEMS, Krailling (DE)

(72) Inventors: Gerd CANTZLER, Neuried (DE); Albert FRUTH, Germering (DE); Bernd LABRENTZ, Windach (DE)

(73) Assignee: EOS GmbH Electro Optical Systems, Krailling (DE)

(21) Appl. No.: 15/541,742

(22) PCT Filed: Dec. 30, 2015
(86) PCT No.: PCT/EP2015/081441

§ 371 Date: Jul. 6, 2017

(30) Foreign Application Priority Data
Jan. 7, 2015 (DE) 10 2015 200 091.5

(51) Int. Cl. B29C 64/393; B29C 64/153; B29C 64/245; B33Y 10/00; B33Y 30/00; B33Y 50/02; B23K 26/08; B23K 26/06; B23K 26/342

(52) U.S. Cl. CPC B29C 64/393; B29C 64/153; B29C 64/245; B33Y 10/00; B23K 26/342; B33Y 50/02; B23K 26/083; B23K 26/0884; B23K 26/0604; B33Y 30/00

(57) ABSTRACT

The invention refers to a device and a method of manufacturing a three-dimensional object. The object (3) is manufactured on at least one support (2) movable in height. The horizontal extent of the support/s defines a construction field (5). An input device (6, 8, 9) directs radiation of at least one radiation source in a controlled way onto regions of an applied layer. The input device (6, 8, 9) directs a plurality of beams simultaneously onto different regions of the applied layer. Each one of the plurality of beams is directed exclusively onto a partial region of the layer assigned to it, wherein the partial region is smaller than the complete construction field (5). The complete construction field (5) is covered by the total number of partial regions. The input device (6, 8, 9) is controlled by means of a control unit (10). At least one of the partial regions overlaps with at least one of the other partial regions partially, but not completely. A sum of overlap areas resulting from such overlaps comprises at least 10% of the total area of the construction field.

The present invention is directed to a device for a manufacturing of a three-dimensional object by means of an additive manufacturing method. It is also related to an additive manufacturing method itself.

Additive manufacturing methods and layer-wise additive manufacturing methods, respectively, may be used for producing a multitude of different objects. Dental crowns, cylinder blocks or shoes shall be mentioned here as examples, wherein different materials such as plastic powder, metal powder or molding sand, etc. are used. The underlying process sequence and the basic setup of a corresponding device are e.g. described in EP 0 734 842 A1 using example of a laser sintering method e.g.

In the method described in EP 0 734 842 A1 there is a laser with related scanning device, by means of which a solidification of the powder at all positions of the construction field is possible. The precision with which details of the object may be produced within an object cross-section depend a.o. on the diameter of the laser beam used for the solidification of the powder. Usually the diameter of the laser beam on the powder layer has a value between several ten and several hundred micrometers.

In particular for large parts and construction fields, respectively, there occurs the problem that the laser beam from the scanner is no longer incident approximately perpendicular on the powder layer to be selectively solidified. Rather, at the positions of the powder layer most distant from the scanning device the larger beam is incident overly aslant. This leads to an undesired excessive enlargement of the area of action of the laser onto the powder layer and thus to a reduction of the precision of details.

The US patent application US 2004/0094728 A1 addresses the just-mentioned problem by mounting the scanning device onto a cross-slide, so that distant positions of the construction field are reached not by a large deflection of the laser beam but by an additional movement of the scanning device on the cross-slide across the construction field. However, a mounting of the scanning device on a cross-slide leads to a longer construction time as the scanning device has to be moved by means of the cross-slide before a solidification process.

The German patent application DE 43 02 418 A1 deals with the problem that the laser beam cannot be moved arbitrarily fast across a layer. First and foremost the patent application describes a stereolithographic method, however, also powders are mentioned as materials. According to DE 43 02 418 A1 a plurality of radiation sources, each having a dedicated deflection device for the laser beam, is suggested. Thereby, different regions of a construction field may be irradiated and solidified simultaneously. In the process, either a separate region of the layer is assigned to each laser beam or else a region is solidified in such a way that several beams are scanned alternatingly over neighboring line-shaped regions.

WO 2014/199134 A1 addresses the problem that delays occur though a building material layer is simultaneously irradiated with several lasers at different positions. According to WO 2014/199134 A1 the problem is that, independent of the shape of an object cross-section, there exist deflection devices that remain nearly inactive because in the regions of the building material layer assigned to them there exist only few positions to be solidified, while other deflection devices have to direct the laser radiation to all positions within their working regions. The necessary solidification time for an object cross-section then is determined by the slowest link of the chain, namely that deflection device that has to solidify the largest area in its working region and needs the longest time for a solidification in its working region, respectively. In order to solve the problem, WO 2014/199134 A1 suggests overlapping the working regions assigned to the deflection devices such that a deflection device that is nearly inactive may be used in an overlap region with the working region of a neighboring deflection device.

As the position of the object cross-section may vary from layer to layer and moreover an object cross-section may have a complex geometry, an automatic decision, which laser has to be used at which positions in an overlap region, in other words a coordination of the beams directed onto the material for a solidification thereof, is not always easy.

Therefore, it is an object of the present invention to provide an alternative and/or improved device for carrying out a layer-wise additive manufacturing method and a corresponding layer-wise additive manufacturing method. Here, it is in particular intended to make the implementation of the layer-wise manufacturing method simpler.

The object is achieved by a device according to claim 1 and a method according to claim 14. Further developments according to the invention are mentioned in the dependent claims. Here, further developments and embodiments, respectively, mentioned in the dependent claims and in the description of the device below may also be regarded as further developments and embodiments, respectively, of the inventive method and vice versa.

A device of the type mentioned in the beginning comprises according to the invention:
At least one support movable in height, on which the object is manufactured and the horizontal extent of which defines a construction field,
an input device for a controlled direction of radiation of at least one radiation source onto regions of an applied layer of a building material within the construction field corresponding to an object cross-section.

Here, the input device is formed such and/or its operation is controlled such that it is able to direct a plurality of beams simultaneously onto different regions of the applied layer and in such a way that each one of the plurality of beams can be directed exclusively onto a (in particular fixed) partial region of the layer of the building material assigned to it, wherein the partial region is smaller than the total construction field and the total construction field is covered by the total number of partial regions. Moreover, the device for manufacturing a three-dimensional object further has a control unit for controlling the input device such that each of the beams acts on the building material where it is incident on the layer, in particular such that the building material is solidified. Here, at least one of the partial regions overlaps with at least one other of the partial regions partially, but not completely. A sum of overlap areas resulting from such overlaps comprises at least 10% of the total area of the construction field. In particular, the control unit (10) is designed such that it directs a plurality of beams simultaneously onto at least a part of an overlap region such that the regions of incidence of the plurality of beams intersect.

By the device according to the invention it is possible to solidify an object cross-section at several positions simultaneously, which leads to a reduction of the construction time for an object:

In the device according to the invention there is a certain overlap of partial regions, so that for the solidification a beam, to which a partial region having few positions to be solidified is assigned, may be applied in a neighboring partial region, in which many positions have to be solidified. Furthermore, in case the areas of incidence coincide in the simultaneous solidification with several beams, this leads to a gain in speed as the singular beams need to input fewer energy and thus may be moved faster across the building material. Preferably, when regions of incidence overlap, an at least partially common, i.e. connected, melt pool of the building material is generated, whereby a synergistic use of several beams for a melting of the building material can be e.g. implemented.

In particular, the device according to the invention makes it possible to automatically coordinate in a simple way a plurality of beams, which are simultaneously directed onto a region for a solidification of the building material therein. The shape of the object cross-section to be solidified need not be taken into account for the coordination as the regions of incidence of the beams merely have to be aligned with respect to each other.

Examinations of objects having different shapes that were manufactured for test reasons have further revealed that a noticeable reduction of the manufacturing time due to the just-described procedure will on average occur, if the overlap sum comprises the above-mentioned value of at least 10% of the total area of the construction field. Here, the reduction of the manufacturing time is the larger, the larger the overlap sum, so that for the latter preferably a value of at least 20%, particularly preferably of at least 40% of the total area of the construction field is advantageous.

In tests an upper limit for the overlap sum of at most 80%, in particular at most 60% of the total area of the construction field proved to be of value. This is related to the above-described problem of an overly aslant energy input by a beam.

Though the invention is preferably applicable to devices, in which electromagnetic beams of the same wavelength are used for a solidification of the building material, the invention may be applied in the same way to devices, in which a solidification is carried out by means of particle beams (e.g. by means of electrons).

Preferably, the extent of coincidence of the regions of incidence should be at least 80%, more preferable substantially 100%, of the area of one of the regions of incidence of the plurality of beams. In this case there is not only achieved an advantage in speed during the solidification. Rather, also the region, into which energy is input is defined more precisely, so that the temperature distribution in the construction field can be controlled in a better way. A coincidence of exactly 100% cannot be achieved in particular, if the areas of incidence have a similar size but are differing in shape. Even when using for example two beams having the same wavelength, this problem may occur, if the two beams are incident on the building material at a different slant as it was already mentioned in the beginning.

Preferably, the total energy input by the plurality of beams at their points of incidence in the overlap region corresponds to a predetermined solidification energy for the building material at a position of the object cross-section outside of the overlap region. In this way, an energy input into the building material as homogenous as possible, independent of the number of beams that are simultaneously used for a solidification, is guaranteed.

Further preferably, the control unit is designed such that it directs exactly two beams, namely a first beam and a second beam, simultaneously onto at least a part of an overlap region. In this way the coordination of the beams and in particular the coordination of the total energy input into the building material by several beams simultaneously becomes very simple, in particular if the two beams input the same amount of energy into the overlap region.

Further preferably, for a solidification of the building material the two beams are moved over the part of the overlap region one trailing the other before the regions of incidence of the two beams coincide, wherein the distance between the regions of incidence decreases monotonically until the regions of incidence coincide. By such an approach large local temperature differences, which are due to an increase of the number of simultaneously acting beams, are avoided. Particularly preferably, at first only the first beam is directed to the part of the overlap region and inputs at least 100%, preferably substantially 100%, of the predetermined solidification energy into the building material (11). Then, the second beam is additionally directed to the part of the overlap region, wherein the solidification energy input by the first beam is monotonically reduced substantially starting with an intersection of the regions of incidence of both beams. At the same time the solidification energy input by the second beam is monotonically increased until, when the regions of incidence coincide by at least 80%, preferably by substantially 100%, the first beam and the second beam together input substantially at least 100%, preferably substantially 100%, of the predetermined solidification energy into the building material. With such a control of the energy input by the beams into the material, it is particularly possible to avoid large temperature differences in a small space.

Further preferably, when switching from a simultaneous irradiation with two beams to an irradiation with only one beam, after a coincidence of the regions of incidence of the beams by at least 80%, preferably substantially 100%, for a solidification of the building material the two beams are moved across the overlap region one following the other, wherein the distance of the regions of incidence is monotonically increased until only one of the two beams is directed to the overlap region. By such an approach large local temperature differences, which are due to a reduction of the number of simultaneously acting beams, are avoided. Here, a procedure is particularly preferable, in which, when the regions of incidence coincide with at least 80%, preferably with substantially 100%, both beams together input at least 100%, preferably substantially 100%, of the predetermined solidification energy into the building material. Here, the energy input by one of the two beams is monotonically reduced and the energy input by the other beam is monotonically increased, when the distance between the regions of incidence monotonically increases, so that in the end only one of the two beams is directed to the part of the overlap region and inputs there at least 100%, preferably substantially 100%, of the predetermined solidification energy. Again, in this way large temperature differences in a small space can be avoided.

Preferably, at least one of the partial regions overlaps with more than one other partial region partially but not completely. Here, particularly preferably at least one of the partial regions has a zone, in which it overlaps with at least two other partial regions. Thus, a multiple partial overlap of at least one partial region with other partial regions is implemented, in particular such that a zone results, which is formed by at least three, preferably even four, partial regions that overlap with one another in the zone. Thereby, in the area of this zone a.o. the synergistic effect due to several beams that can be directed to this zone is increased because the beams may complement each other considerably better.

According to an advantageous further development all partial regions have the same dimensions. This leads for example to a better overview for a user and also makes the control of the beams simpler.

In principle, the partial regions may have any shape. Preferably, at least one partial region, particularly preferable all partial regions are rectangular, in particular square-shaped.

Though it is essentially possible that only some partial regions overlap with other partial regions, while others do not, with respect to an improved synergy preferably each of the partial regions overlaps with its neighboring partial regions.

In particular with respect to an improvement of the above-mentioned overview and control it may be advantageous that the extent of overlap with a neighboring partial region is the same for all overlapping partial regions.

According to a further development of the invention several partial regions overlap with their neighboring partial regions and an extent of the overlap of the sides in a first arrangement direction of the partial regions differs from an extent of the overlap of the sides in a second direction that is transverse, preferably perpendicular to the first direction.

Further preferably, the sides of two neighboring partial regions substantially overlap with each other along their whole extent in a direction of space. This again facilitates the above-mentioned clarity of arrangement and controllability.

Preferably the construction field is rectangular, in particular square-shaped, with four partial regions arranged in the corners of the construction field.

Further preferably there are in total at least three partial regions, preferably four, especially preferably at least six or very specifically preferred at least ten partial regions.

In particular it is preferred—for example due to the simple geometrical arrangement—that the number of partial regions is even, wherein it is particularly preferred that the partial regions are arranged in at least one row of two.

According to a particular embodiment, the partial regions are arranged with respect to one another such that at least a portion of the arrangement thereof substantially completely or partially has the shape of an open or closed circle or ellipse. This may mean, however, need not necessarily mean, that the build are itself has a (semi-)round or (semi-) elliptical shape at its outer periphery. Alternatively, angular partial regions may also be arranged such that they overlap with each other in a way in which they are not arranged along a common line or in a column or row arrangement but in a (semi-)circle or (semi-) ellipse. Here, within the scope of this particular embodiment, in general there need not be a construction field at the center of such an arrangement. Rather, the arrangement may define an open or closed (circular or elliptical) annulus.

In particular, in order to increase synergy, i.e. a better cooperation of the individual beams with one another, the total overlap preferably corresponds to at least 20%, particularly preferably at least 40% of the total area of the construction field.

On the other hand, a total overlap that is too large means that the construction field may not be chosen arbitrarily large due to the above-described necessity of avoiding beam angles that are too large. Against this background the total overlap is at most 80%, particularly preferably at most 60% of the total area of the construction field.

According to the invention an additive manufacturing method for manufacturing a three-dimensional object by means of a device comprises the following steps:
building the object on at least one vertically movable support, the horizontal dimensions of which define a construction field (5),
a controlled direction of radiation of at least one radiation source to regions of an applied layer of a building material within the construction field that correspond to an object cross-section by means of an input device,
wherein the input device directs a plurality of beams simultaneously to different regions of the applied layer,
and each of the plurality of beams is directed exclusively to a partial region of the layer of building material assigned to it, wherein the partial region is smaller than the total construction field and wherein the total number of partial regions covers the complete construction field,
wherein at least one of the partial regions overlaps with at least one of the other partial regions partially, but not completely, and a sum of overlap areas formed by such overlaps includes at least 10% of the total area of the construction field,
wherein the input device is controlled such that each of the beams affects the building material in its region of incidence, meaning where it is incident on the layer, in particular such that the building material is solidified,
wherein a plurality of beams is simultaneously directed onto at least a part of an overlap region such that the regions of incidence of the plurality of beams intersect.

By the additive manufacturing method according to the invention the advantages described with respect to the above-described additive manufacturing devices in all variants may be achieved, in particular in case such a method is carried out on one of these devices.

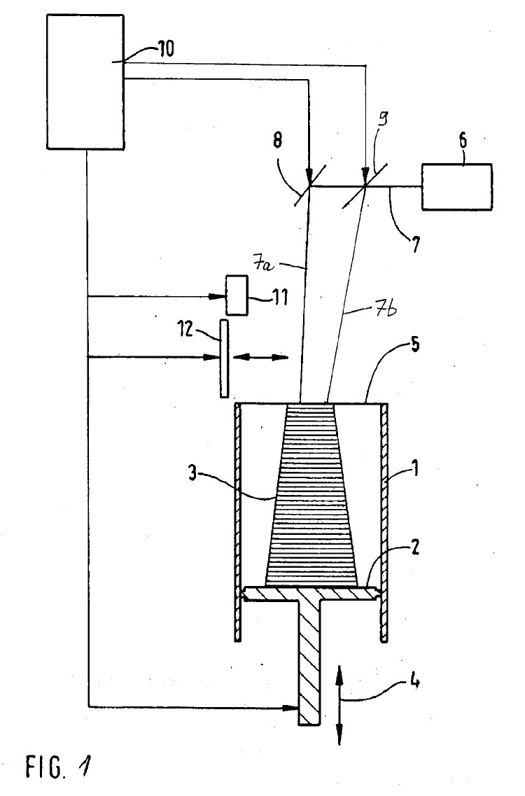

FIG. 1 shows the schematic setup of an embodiment of a device according to the invention.

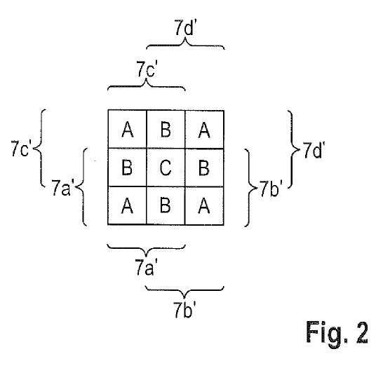

FIG. 2 shows a top view of the construction field with partial regions scanned by laser beams for an example having four laser beams.

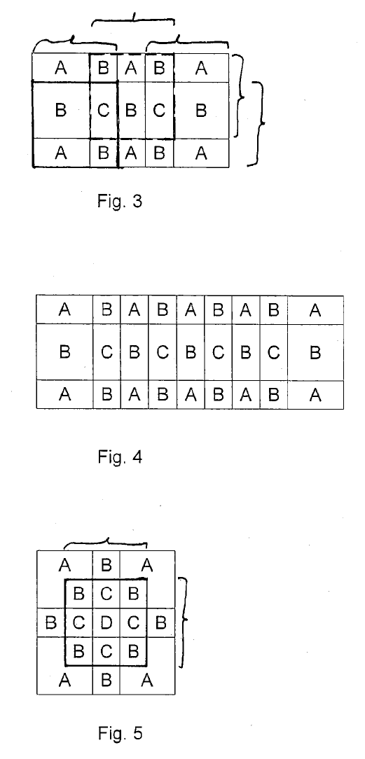

FIG. 3 shows a top view of the construction field with partial regions scanned by laser beams for an embodiment with six partial regions.

FIG. 4 shows a top view of the construction field with partial regions scanned by laser beams for an embodiment with ten partial regions.

FIG. 5 shows a top view of the construction field with partial regions scanned by laser beams for an embodiment with five partial regions.

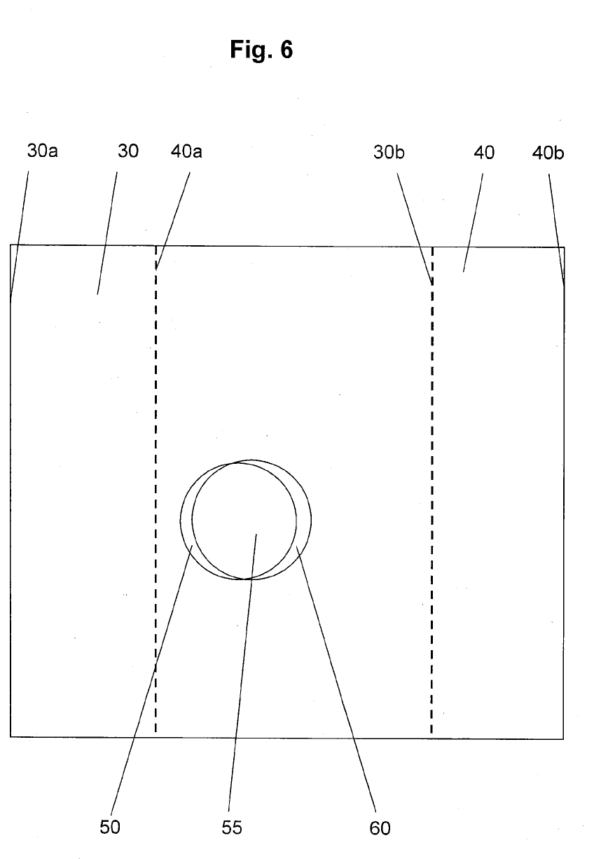

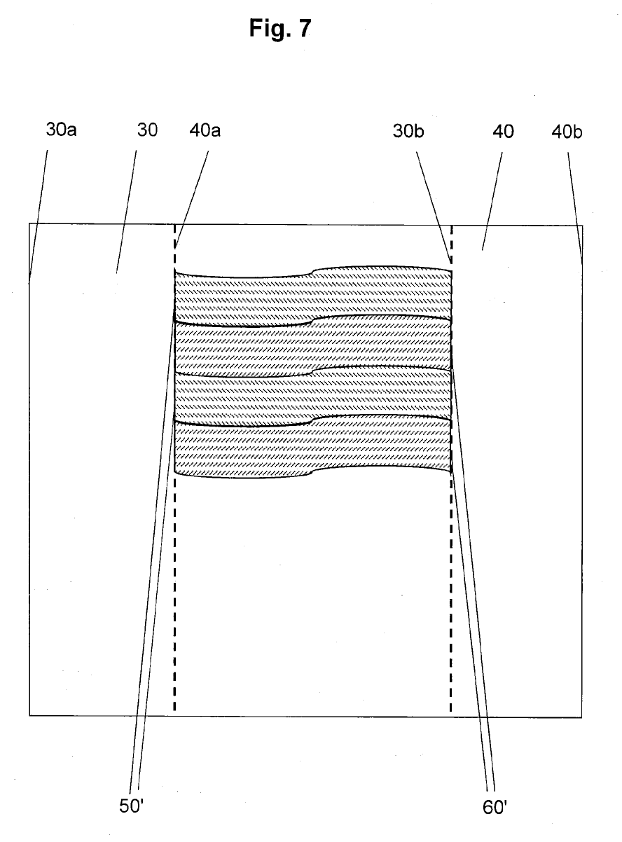

FIG. 6 shows a top view of two partial regions of the construction field overlapping with each other in order to illustrate a solidification according to the invention in the overlap region by several beams.

FIG. 7 shows a top view of two partial regions of the construction field overlapping with each other in order to illustrate an alternative solidification according to the invention in the overlap region by several beams.

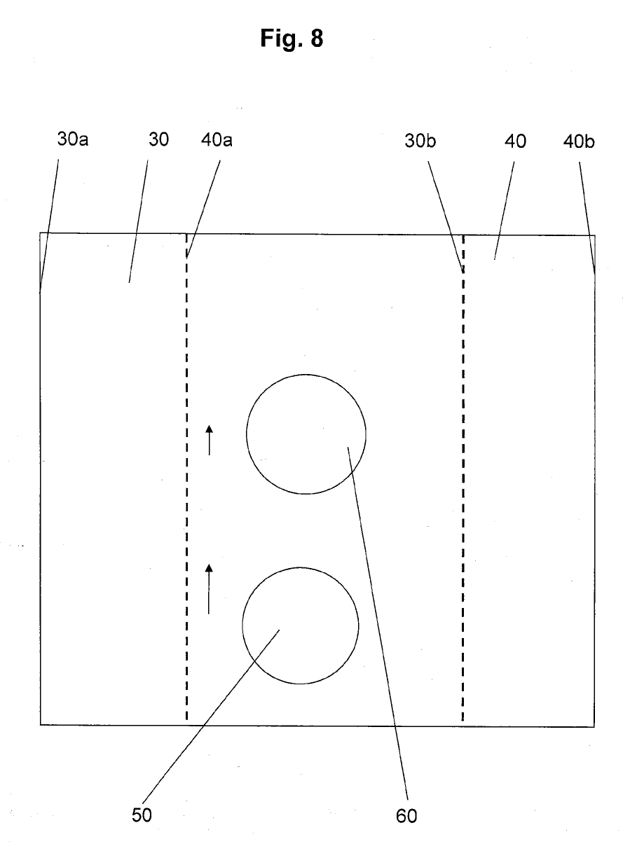

FIG. 8 show a top view of two partial regions of the construction field overlapping with each other in order to illustrate a procedure according to the invention when changing the number of beams that are simultaneously used for solidifying a region.

In the present application the term “additive manufacturing method” in general means a building method, in which objects are manufactured from a shapeless material, in particular a powder, by a layer-wise solidification. For doing so, in particular laser energy is used as radiation energy, as will be further explained in the following examples. Therefore, in the following a “laser” will be described as an example of a radiation source without limiting thereby the scope of the disclosure. The present invention can be implemented not only with laser radiation, but can be implemented also with other electromagnetic radiations, in particular also with particle radiation (e.g. electron beams). In particular, the present application is directed to such a primary shaping method, in which an object is manufactured with the desired shape without making use of external molds in that those positions in a building material layer that shall be solidified to make up a cross-section of the object to be manufactured are irradiated with a laser, wherein the point of interaction of the laser with the layer is changed by means of a scanner. Examples for such a method are selective laser melting, selective laser sintering as well as stereolithographic methods.

In the present application the term “solidifying” means a process of irradiating a liquid building material or building material in powder form such that the building material is partially or completely melted at the positions, at which heat energy has been input by the radiation, so that the building material exists in a solid state after having cooled down. Here, a predetermined solidification energy corresponds to the heat energy per unit area to be input for the solidification process. Therefore, when in the following a “predetermined heat amount to be input” is mentioned, this means that within the area to which this statement refers the heat energy per unit area that is to be input for the solidification process is input at all positions.

In the present application, the term “region of incidence” designates the area of that region of the building material surface, in which a beam interacts with the building material, which means inputs heat”. Preferably that region is regarded as region of incidence, in which due to the interaction a solidification of the building material is effected. Preferably, according to the present invention, there is an intersection of regions of incidence, if the regions in which a solidification is effected that are assigned to the individual beams overlap. In case a solidification is effected in that each beam creates a melt pool in the building material layer, an intersection of beams preferably exists, if the melt pools assigned to the individual beams combine to a common melt pool.

Furthermore, it shall be emphasized that in the present application the term “beam” is not limited to radiation that is almost point-shaped when hitting a powder layer. The term also covers radiation, which e.g. is line-shaped or else is incident in a beam spot which due to its dimension cannot be characterized as “point-shaped”. Here, it is of particular importance that a beam sequentially scans the partial region assigned to it.

In the following a description of a device according to the invention is given, wherein as example for the (here laser-based) additive manufacturing method a laser sintering method has been chosen.

The device shown in FIG. 1 has a building container 1, in which a support 2 for supporting an object 3 to be manufactured is provided. The support 2 can be moved in the building container 1 in a vertical direction by means of a height adjustment device 4. The plane in which the applied building material in powder form is solidified, defines a working plane. That part of the working plane that is surrounded by the building container 1 or else a specifically defined region in the part of the working plane that is surrounded by the building container 1 is designated as construction field 5. Usually, the dimensions of the construction field are identical to the horizontal dimensions of the support. In order to solidify the material in powder form in the construction field 5, a laser 6 is provided that generates a laser beam 7, which is focused onto the construction field 5 by means of deflection devices 8 and 9. Within the scope of the invention there may also be provided several lasers and/or another plurality of deflection devices.

In FIG. 1 as an example two deflection devices (scanners) are shown, to which light is supplied by the laser 6. Here, the laser beam 7 generated by the laser 6 is split up (not shown in detail) into a laser beam 7a that is reflected at the deflection device 8 and a laser beam 7b that is reflected at the deflection device 9. Each of deflection devices 8 and 9, which are only schematically shown, may be a pair of galvanometer mirrors that is controlled by a control 10. Here, the control 10 accesses data that include the structure of the object to be manufactured (a three-dimensional CAD layer model of the object). In particular, the data include a precise information on each layer to be solidified, wherein each layer to be solidified is assigned to a cross-section of the object to be manufactured. In accordance with the data the deflection devices 8 and 9 are driven such that the laser beams 7a and 7b are deflected to those positions of the construction field 5, at which a solidification in a layer of the applied building material in powder form shall be effected by the action of the laser light.

FIG. 1 schematically shows a supply device 11, by which the building material in powder form for a layer can be supplied. By means of a recoater 12 the building material then is applied in the construction field 5 with a certain layer thickness and is smoothened.

In operation, the support 2 is lowered layer by layer, a new powder layer is applied and is solidified by means of the laser beams 7a and 7b at positions of the respective layer in the construction field that correspond to the respective object.

The basic setup of a laser melting device is identical to the one just described.

All powders and powder mixtures, respectively, that are suitable for a laser sintering method or laser melting method may be used as building material in powder form. Such powders include e.g. plastic powders such as polyamide or polystyrene, PAEK (polyarylether ketones), elastomers such as PEBA (polyether block amides), metal powders (e.g. stainless steel powder but also alloys), plastic-coated sand and ceramic powders.

According to the invention a plurality of deflection devices is provided. The number thereof need not be limited to two deflection devices shown in FIG. 1 by way of example.

As will be explained in the following based on FIG. 2, a partial region of the construction field 5 is assigned to each deflection device. This means that the (partial) region onto which the laser beam may be deflected by means of a deflection device is limited and includes only a fixed part of the construction field.

FIG. 2 shows an embodiment of the invention in which there are four laser beams that can be directed onto the construction field. In particular, FIG. 2 shows a top view of the construction field, which construction field in this embodiment is square-shaped. There are four partial regions 7a′, 7b′, 7c′ and 7d′ shown schematically, which are those partial regions that can be scanned by the corresponding laser beams 7a, 7b, 7c and 7d. This means that a partial region 7a′ is assigned to the laser beam 7a, a partial region 7b′ is assigned to the laser beam 7b, etc.

In particular, it can be seen in FIG. 2 that the square-shaped partial regions 7a′, 7b′, 7c′ and 7d′ partially overlap with each other. Thus, partial regions 7a′ and 7b′ overlap with each other in a horizontal direction in FIG. 2. The same applies to partial regions 7c′ and 7d′.

Furthermore, in FIG. 2 the partial regions 7a′ and 7c′ overlap with each other in a vertical direction. The same applies to partial regions 7b′ and 7d′.

By the just-described arrangement of partial regions in the construction field 5 that are scanned by the laser beams it becomes possible that in the overlap regions of two partial regions a solidification of the building material may be effected by both the laser beam assigned to one partial region and the laser beam assigned to the other partial region. As the laser beams assigned to the individual partial regions preferably are simultaneously directed onto the construction field, by the chosen arrangement the building material can be solidified more quickly in the overlap regions because in the overlap regions two laser beams can solidify the material simultaneously.

In FIG. 2 different regions of the construction field are designated with capital letters A, B and C. This shall indicate to the number of laser beams by which a corresponding region can be reached:
The regions marked with A can be reached with only one laser beam.
The regions marked by B can be reached with two laser beams.
The region marked by C can be reached with four laser beams.

When a cross-section of a large object is solidified in the construction field 5, the portion of the area to be solidified tends to be larger in the center of the construction field 5 than in the corners of the construction field 5. Therefore, in FIG. 2 by the chosen arrangement of the partial regions assigned to the laser beams, in particular the center of the construction field 5 can be solidified more quickly than the corners. Here, of course, in the center of the construction field 5 there is not locally a higher input of energy at a particular position of the powder layer during the solidification process. Rather, in the center of the construction field 5, several laser beams may “share the work”. For example, in the regions marked with B each one of the two laser beams may input at a position half of the energy necessary for the solidification. Alternatively, a region B may be scanned such with parallel scanlines of laser beams that a scanline of one laser beam is always located between two neighboring scanlines of the other laser beam. In the region C a solidification is effected correspondingly with four laser beams.

Thus, within a layer the solidification is effected with several laser beams simultaneously. Though the cross-section of an object may be located at different positions within the construction field, by the approach according to the invention the time needed for solidifying a cross-section can nevertheless be reduced. Due to the overlap of the partial regions assigned to the individual laser beams in the inner part of the build area, the solidification may be effected quicker in that region where the area in which building material has to be solidified tends to be larger. At the same time there is no redundancy of laser deflection devices, but the existing number of laser deflection devices is effectively used.

As already mentioned in the introduction, for larger objects to be manufactured it is anyhow advantageous to solidify a partial region of the construction field only by the action of one laser beam out of reasons of a higher precision of details. Thus, by the inventive approach not only a considerably short building time is achieved but also a high precision of details is achieved.

As in the overlap regions of laser beams where the powder is to be solidified there must not be input more energy than in regions, in which only one laser beam is active, the plurality of laser beams has to be coordinated in the overlap regions. This can be effected for example by the control 10, which controls the individual deflection devices.

FIG. 6 shows a top view of two partial regions 30 and 40 of the construction field that overlap with each other in order to illustrate the approach according to the invention when solidifying the building material in the overlap region of two partial regions with several beams. Here, each of the two partial regions 30 and 40 is rectangular and extends in a horizontal direction between the sides 30a and 30b and the sides 40a and 40b, respectively. Therefore, in FIG. 6 the overlap region extends in a horizontal direction between the lines 40a and 30b. When using several laser beams simultaneously for solidifying the building material in the overlap region, according to the invention the beams are coordinated with each other such that when scanning the building material the regions of incidence of the beams intersect on the layer. In FIG. 6 this is shown using the example of two beams. Here, the reference number 50 designates a region of incidence of a first laser beam and the reference number 60 designates the region of incidence of a second laser beam. The two regions of incidence are approximately circular only by way of example. The intersection or coincidence region of both regions of incidence 50 and 60 has the reference number 55. In the example according to the invention a first laser beam is directed on the region of incidence 50 by the deflection device 8 and a second laser beam is directed on the region of incidence 60 by the deflection device 9. For a solidification of the building material, the two regions of incidence are moved synchronously across the building field in the overlap region, wherein preferably the size of the area of the coincidence region 55 does not change. In order to limit the energy input into the coincidence region 55, the energy of the two beams that are deflected by the deflection devices 8 and 9 is reduced such that the energy input into the coincidence region 55 substantially is the same as the energy input at other positions in the applied building material layer. Thus, the beam assigned to the region of incidence 50 could supply 50% of the energy to be input and the beam assigned to the region of incidence 60 could also supply 50% of the energy. However, it would also be possible that for example the first beam (assigned to the region 50) inputs only 30% of the energy and the beam assigned to the region 60 inputs 70% of the energy. Of course, arbitrary combinations are possible as long as in the end in the coincidence region 55 at least 100% of the predetermined energy to be input is inputted. The predetermined energy to be input for solidifying the building material here depends on the type of building material, on its densification during layer application, on the working temperature at which the radiation is directed onto the building material and on other parameters. Preferably, when the size of the area of the coincidence region is changed, the energy input by the individual beams is adapted such that in the coincidence region at least 100% of the predetermined solidification energy is input. In order to avoid difficulties that result from an incomplete coincidence of the two regions of incidence, preferably a (approximately, i.e. substantially) complete overlap of the two regions of incidence 50 and 60 is aimed at. Though in FIG. 6 only two regions of incidence 50 and 60 are illustrated, the approach according to the invention is of course also possible when there are more than two regions of incidence (more than two beams used for a solidification).

As illustrated in FIG. 7, alternatively to the approach shown in FIG. 6, the simultaneous solidification within the overlap region may also be effected such that scanlines lying next to each other, to which different laser beams are assigned, are simultaneously solidified. The overlap region in FIG. 7 corresponds to the one in FIG. 6. In FIG. 7, however, the regions of incidence 50 and 60 are not shown. Rather, FIG. 7 shows resulting scanlines 50′ and 60′ that result from moving the regions of incidence 50 and 60 across the construction field. Thus, in the embodiment of FIG. 7 the regions of incidence 50 and 60 would be moved at first along the two upper lines 50′ and 60′ in FIG. 7 (for example starting at the boundary 40a of the overlap region and ending at the boundary 30b of the overlap region) in order to solidify the building material along the scanlines 50′ and 60′. Then in the two lower scanlines 50′ and 60′ the two regions of incidence 50 and 60 would be again simultaneously moved for example from right (beginning at the line 30b) to left up to the line 40a. In each case there exists between the lines 50′ and 60′ a coincidence region not shown in FIG. 7, which results from an overlap of the two regions of incidence 50 and 60 in a vertical direction in the figure. If such coincidence region is small, the energy input along each of the two scanlines 50′ and 60′ lying next to each other does not have to be adapted to this circumstance. However, if there is a remarkable overlap of scanlines 50′ and 60′, the energy input along the individual scanlines 50′ and 60′ can be reduced a bit, if necessary.

By the approach according to the invention it is possible to easily coordinate a plurality of beams, with which material is simultaneously solidified within a region, with respect to one another. By coupling the beams with each other, an automatic coordination of the beams is easily possible independent of the shape of the cross-sectional region to be solidified within an overlap region of partial regions. The shape of the cross-section to be solidified does not at all have to be taken into consideration for the coordination of the beams. For example, it is sufficient that one of the beams is chosen as lead beam and the other beams are merely adjusted to this lead beam such that there is at least a partial coincidence of the regions of incidence of the beams.

Moreover, it has to be remarked that a success according to the invention will already be achieved in case only a part of the overlap region is solidified in the way according to the invention.

FIG. 3 shows an embodiment of the invention, in which the rectangular construction field is covered by six partial regions each of which is assigned to a laser beam. Out of clarity reasons the outlines of only two partial regions are highlighted. However, the positions of the partial regions are indicated by braces. Again, in the regions designated by A only one laser beam is active. In the regions designated by B an overlap of two partial regions with each other exists and in the regions designated by Can overlap of four partial regions exists. In particular, it can be seen in FIG. 3 that the extent of the overlap of partial regions in the horizontal direction in the figure differs from the extent of the overlap in a vertical region in the figure. Here, by the arrangement of the partial regions in FIG. 3 more than 50% of the construction field can be illuminated with more than one laser beam.

FIG. 4 shows an embodiment, in which ten partial regions are shown instead of six partial regions. The arrangement of partial regions and also the arrangement of the individual regions A, B and C correspond to the arrangement in FIG. 3. Based on FIG. 4 it can be seen that the invention can be implemented with an arbitrary number of partial regions. For eight, twelve, fourteen, etc. partial regions the corresponding division of the construction field would be analogous.

FIG. 5 shows a further embodiment with five partial regions. Here, four partial regions are arranged as in FIG. 2. Only the additional fifth partial region is highlighted and its position is marked with braces. Again, in the regions designated by A only one laser beam is active. In the regions designated by B an overlap of two partial regions with each other exists and in the regions designated by C an overlap of four partial regions exists. Due to the additional fifth partial region five laser beams may be simultaneously active in the center of the construction field (region D). An approach corresponding to the one in FIG. 5 is also possible with a different uneven number of laser beams. For example, also in the arrangements of FIG. 3 and FIG. 4 additional partial regions could be placed in the center in the same way as in FIG. 5.

A further development of the invention optimizes the procedure when the number of laser beams simultaneously used in a region for a solidification is changed. In particular, when regions of incidence of beams coincide only at times, it is important to control the energy input by the individual beams in order to guarantee that on the one hand sufficient energy for a solidification of the building material is input and on the other hand a predetermined energy amount to be input is not exceeded too much. Preferably, exactly the predetermined energy amount to be input is input. Furthermore, the spatial distribution of the regions of incidence across the building material also plays a role with respect to possible stress and curl effects in the object to be manufactured that occur during the solidification. By the spatial distribution of the regions of incidence of the beams the temperature distribution within the object cross-section to be solidified is strongly influenced. Here, high temperature differences usually result in stress in the material.

In order to avoid abrupt changes of the temperature distribution within the building material layer, the inventive approach is the one shown by way of example in FIG. 8. Like FIGS. 6 and 7, FIG. 8 shows a top view of (in this example two) partial regions of the construction field that overlap with each other. In particular, again there are shown regions of incidence 50 and 60 of two laser beams in the overlap region of both partial regions between lines 40a and 30b. An approach according to the invention can be for example as follows:
i) At first, the solidification is carried out in the overlap region only by the first laser beam to which the region of incidence 50 is assigned. Here, the laser beam inputs into the building material at least 100%, preferably substantially 100%, of the predetermined energy to be input for the solidification of the same.
ii) After the second laser beam, to which the region of incidence 60 is assigned, has been directed onto the building material layer within the overlap region, the second laser beam inputs immediately at the start of its movement across the object cross-section in the overlap region 0% of the predetermined energy to be input. With progressing time the distance between the two regions of incidence 50 and 60 is reduced more and more. For example, this may be effected by moving the regions of incidence across the construction field with different velocity, wherein, as shown in FIG. 8, for example the region of incidence 50 follows in its movement the region of incidence 60, however is moved with higher velocity than the region of incidence 60. Basically as soon as the regions of incidence 50 and 60 start to intersect, the energy input by the first laser is reduced following a monotonically decreasing function. In the same way, however, the energy input by the second laser is increased. Thus, there is a point in time starting from which there exists a coincidence of both regions of incidence of at least 80%, further preferably 100%, and the sum of the energies input by the first laser and the second laser beam again results in at least 100%, preferably substantially 100%, of the predetermined energy to be input.

Of course, the approach is not limited to the example of FIG. 8. In the same way the region of incidence 60 could just as well move towards the region of incidence 50, for example when the second laser beam follows the first laser beam.

In a case in which there is a switch from an irradiation with several laser beams simultaneously to an irradiation with only one laser beam, an approach analogously to the one described in FIG. 8 is also possible. In this case the procedure is simply carried out reversely, for example as follows:
i) At first, both beams are moved synchronously across an object cross-section to be solidified within the overlap region shown in FIG. 8 with a coincidence of their regions of incidence of at least 80%, preferably with a substantially complete coincidence of their regions of incidence.
ii) Then, for example the velocity of the second beam is reduced so that the area of the coincidence region is reduced more and more and finally the second beam trails the first beam. For an illustration of this it is sufficient to simply imagine that the arrows shown in FIG. 8 point from the top to the bottom. Simultaneously with the increase of the distance between the regions of incidence 50 and 60 the energy input by the second beam is reduced following a monotonically decreasing function and the energy of the first beam is increased correspondingly.
iii) Finally, when the two regions of incidence substantially do no longer overlap, the solidification in the overlap region is carried out only by the first beam, which then inputs at least 100%, preferably substantially 100%, of a predetermined energy to be input.

Of course, again instead of slowing down the second beam, the first beam can be accelerated or instead of slowing down the second beam the first beam can be slowed down relative to the second beam. In the latter case in the end there is a situation, in which only the second beam inputs energy into the overlap region for a solidification of the building material.

The approach described by making use of FIG. 8 is not limited to two beams used simultaneously for a solidification in the overlap region. Furthermore, when the second beam is added in FIG. 8, the second beam at the beginning need not necessarily input into the material substantially 0% of the predetermined energy to be input, even if the regions of incidence still do not yet intersect. For example, the added beam may input at the beginning 20% of the predetermined energy. In this case, a delayed cooling-down of the material after the solidification with the first beam would be caused, if the second beam follows the first beam. In case the second beam at first moves ahead of the first beam, the second beam would pre-heat the material before a solidification of the same by the first beam. Analogously, the energy of the beam to be switched off need not necessarily be reduced to 0% before switching it off. Rather, before removing it, it could for example be reduced to only 20%, even if the regions of incidence do no longer intersect.

Furthermore, by the addition and removal of beams as described based on FIG. 8, also a switching from one beam to another beam for the exposure can be easily implemented. If, for example, at first only the first beam solidifies in the overlap region, it will be possible to switch to a solidification only by the second beam by means of the approach described with respect to FIG. 8. By the described approach it is guaranteed that during the switching no temperature variations and inhomogeneities, respectively, occur in the building material, so that mechanical errors or dimensional errors in portions of the object to be manufactured are prevented.

Moreover, an approach described based on FIG. 8 also makes possible controlled “encounters” of two or more beams in a joint solidification within an overlap region. It is then no problem that two or more beams come very close to each other in the joint solidifying process or that the assigned regions of incidence coincide occasionally though the regions of incidence most part of the time do not coincide.

The described embodiments of the invention may be varied in various ways:

The beams need not all be generated by means of a single radiation source that interacts with several deflection devices. It is definitely possible to assign to all or only to some of the deflection devices individual radiation sources or to assign to a radiation source a number of deflection devices, which number is smaller than the total number of deflection devices. Furthermore, the radiation sources need not necessarily all be identical, though preferably this should be the case.

Though in the embodiments only square-shaped partial regions are shown, it is also conceivable that rectangular partial regions are provided. The dimensions of a partial region here may be simply determined by the control 10.

Even if in the embodiments always all neighboring partial regions overlap with each other, there are already advantages due to the invention if only a subset of the partial regions overlaps with each other.

Furthermore, in the embodiments all partial regions are arranged such that their sides are parallel to one another. However, this need not be the case. For example, in the example of FIG. 5 it would also be possible that the square at the center (the fifth partial region) is rotated around an axis that is perpendicular to the drawing plane.

Though in all embodiments partial regions are shown that end at the boundaries of the construction field, of course the invention is also realizable in a case in which a beam due to the optical setup could also act outside of the construction field. In such a case the control 10 will have to prevent an exposure outside of the construction field. (Thus, the control defines the region onto which a beam may be theoretically directed by a galvanometer mirror).

Finally, the invention is also applicable to a case, in which the construction field and/or the partial regions assigned to the beams are not rectangular.

1. A device for manufacturing a three-dimensional object by means of an additive manufacturing method comprises:
at least one support movable in height, on which the object is manufactured, the horizontal extent of which support defining a construction field,
an input device for a controlled direction of radiation of at least one radiation source onto regions of an applied layer of a building material within the construction field corresponding to an object cross-section,
wherein the input device is formed such and/or its operation is controlled such that it is able to direct a plurality of beams simultaneously onto different regions of the applied layer,
wherein each one of the plurality of beams can be directed exclusively onto a partial region of the layer of the building material, which is assigned to it, wherein the partial region is smaller than the total construction field and the complete construction field is covered by the total number of partial regions,
wherein at least one of the partial regions overlaps with at least one other of the partial regions partially, but not completely and a sum of overlap areas resulting from such overlaps comprises at least 10% of the total area of the construction field, and
the device for manufacturing a three-dimensional object further comprises a control unit for controlling the input device such that each of the beams acts on the building material in its region of incidence, which is where it is incident on the layer, in particular such that the building material is solidified,
wherein the control unit is designed such that it directs a plurality of beams simultaneously onto at least a part of an overlap region such that the regions of incidence of the plurality of beams intersect.

2. The device according to claim 1, wherein the beams are electromagnetic beams of the same wavelength.

3. The device according to claim 1, wherein the extent of the intersection of the regions of incidence is at least 80%, of the area of the region of incidence of one of the plurality of beams.

4. The device according to claim 3, wherein the total energy input by the plurality of beams at their points of incidence in the overlap region corresponds to a predetermined solidification energy for the building material at a position of the object cross-section outside of the intersection region.

5. The device according to claim 4, wherein the control unit is designed such that it directs exactly two beams, namely a first beam and a second beam, simultaneously onto at least a part of an overlap region.

6. The device according to claim 5, wherein the two beams input the same amount of energy into the overlap region.

7. The device according to claim 6, wherein for a solidification of the building material the two beams are moved over the part of the overlap region one trailing the other before the regions of incidence of the two beams intersect, wherein the distance between the regions of incidence decreases monotonically until the regions of incidence coincide.

8. The device according to claim 7, wherein at first only the first beam is directed to the part of the overlap region and inputs at least 100% of the predetermined solidification energy into the building material and then the second beam is additionally directed to the part of the overlap region,
wherein the solidification energy input by the first beam is monotonically reduced substantially starting with an intersection of the regions of incidence of both beams and at the same time the solidification energy input by the second beam is monotonically increased until, when the regions of incidence coincide by at least 80%, the first beam and the second beam together input substantially at least 100% of the predetermined solidification energy into the building material.

9. The device according to claim 5, wherein the two beams after a coincidence of their regions of incidence by at least 80% for a solidification of the building material are moved across the overlap region one following the other, wherein the distance of the regions of incidence is monotonically increased until only one of the two beams is directed to the overlap region.

10. The device according to claim 9, wherein when the regions of incidence coincide with at least 80%, both beams together input at least 100% of the predetermined solidification energy into the building material,
wherein the energy input by one of the two beams is monotonically reduced and the energy input by the other beam is monotonically increased, when the distance between the regions of incidence monotonically increases, so that in the end only one of the two beams is directed to the part of the overlap region and inputs there at least 100% of the predetermined solidification energy.

11. The device according to claim 1, wherein at least one of the partial regions has a zone, in which it overlaps with at least two other partial regions.

12. The device according to claim 1, wherein a plurality of the partial regions overlap with their neighboring partial regions and an extent of the overlap of the sides in a first arrangement direction of the partial regions differs from an extent of the overlap of the sides in a second direction that is transverse, to the first direction.

13. The device according to claim 1, wherein the partial regions are arranged with respect to one another such that at least a portion of the arrangement thereof substantially completely or partially has the shape of an open or closed circle or ellipse.

14. An additive manufacturing method for manufacturing a three-dimensional object by means of a device comprising the following steps:
building the object on at least one support movable in height, the horizontal extent of which defines a construction field,
a controlled direction of radiation of at least one radiation source to regions of an applied layer of a building material within the construction field that correspond to an object cross-section by means of an input device,
wherein the input device directs a plurality of beams simultaneously to different regions of the applied layer,
and each of the plurality of beams is directed exclusively to a partial region of the layer of building material assigned to it, wherein the partial region is smaller than the complete construction field and wherein the total number of partial regions covers the complete construction field,
wherein at least one of the partial regions overlaps with at least one of the other partial regions partially, but not completely, and a sum of overlap areas resulting from such overlaps comprises at least 10% of the total area of the construction field,
wherein the input device is controlled such that each of the beams acts on the building material in its region of incidence, which is where it is incident on the layer, in particular such that the building material is solidified,
wherein a plurality of beams is simultaneously directed onto at least a part of an overlap region such that the regions of incidence of the plurality of beams intersect.

15. An additive manufacturing method wherein the additive manufacturing method is carried out on a device according to claim 1.

16. The device according to claim 8, wherein at least one of the partial regions has a zone, in which it overlaps with at least two other partial regions.

17. The device according to claim 9, wherein at least one of the partial regions has a zone, in which it overlaps with at least two other partial regions.
